(19) United States
(12) Patent Application Publication
(10) Pub. No.: US 2020/0039179 A1
(43) Pub. Date: Feb. 6, 2020

(54) A PREFORM WITH LOCAL REINFORCEMENT

(71) Applicants: HEXCEL REINFORCEMENTS UK LIMITED, Duxford, Cambridgeshire (GB); HEXCEL HOLDING GMBH, Pasching (AT)

(72) Inventors: Thomas JAMES, London (GB); Robert FROST, Nottingham (BG); Andreas SAGEDER, Peuerbach (AT)

(73) Assignees: HEXCEL REINFORCEMENTS UK LIMITED, Duxford, Cambridgeshire (GB); HEXCEL HOLDING GMBH, Duxford, Cambridgeshire (AT)

(21) Appl. No.: 16/605,190

(22) PCT Filed: Apr. 23, 2018
(86) PCT No.: PCT/EP2018/060383

§ 371 Date: Oct. 14, 2019

(30) Foreign Application Priority Data
Apr. 25, 2017 (EP) 17020163.6

(51) Int. Cl. B32B 5/12; B32B 5/26; B32B 7/09; B32B 5/02; D04H 1/74

(52) U.S. Cl. CPC B32B 5/12; B32B 5/26; B32B 2262/106; B32B 5/022; D04H 1/74; B32B 7/09

(57) ABSTRACT

The invention provides a method of manufacturing a preform (120) from a reinforcement fabric by depositing a first fibre layer (112) and depositing a second fibre layer (114) partially over the first layer before cutting a plurality of preforms from the reinforcement fabric.

### INTRODUCTION

The present invention is concerned with a method of manufacture of composite preforms, and in particular with a method of manufacture of preforms having a load path orientated ply book.

### BACKGROUND

By “preform” we mean a two- or three-dimensional arrangement of fibre plies having multiple layers, the arrangement being in a pre-cured condition. Preforms are also either formed or cut to the shape in which they will be moulded.

Composite materials are well known and used in many fields of engineering. Composite materials comprise at least two phases constructed from physically and/or chemically distinct materials: a reinforcement and a matrix. In fibre reinforced composites, the fibre is typically a material with high tensile strength but low stiffness. The matrix is usually less strong, but has a relatively high stiffness. When the fibres are placed into (impregnated) with the matrix, a composite material is provided having high strength, high stiffness and relatively low density (both phases are relatively low density compared to e.g. steel).

Because of these properties, and because of other beneficial properties such as corrosion resistance and low thermal expansion, the use of fibre reinforced polymer (FRP) materials is increasing. The combination of properties makes these materials favourable compared to traditional materials (e.g. metals) in many applications in the aerospace and automotive fields and beyond.

One feature of FRP materials is that the fibres (which are normally provided in layers, or plies) are highly anisotropic. The strength in the direction of the fibre axis is significantly higher than in any other direction. Therefore, in continuous or long-fibre forms it is common for several plies to be provided in layers, each ply or layer having fibres oriented in a different direction to the adjacent ply or plies. In this way, the directional properties of the material can be tailored to suit the application.

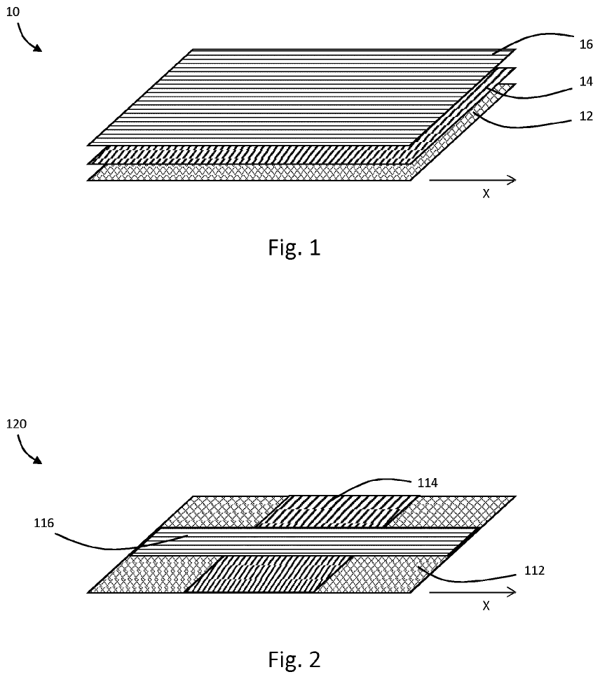

FIG. 1 shows a typical carbon fibre reinforced polymer ply preform 10 in which three layers 12, 14, 16 are provided with fibres oriented at ±45 degrees (layer 12), 90 degrees (layer 16) and 0 degrees (layer 14) to the axis X respectively. This combination of a plurality of layers, or plies, is often referred to as a “ply book”. Each layer is formed from a fibre sheet created from strips of deposited carbon fibre tow. The tows are deposited in a pre-determined orientation in each layer. In this example, the plies are constructed from non-crimp fabrics (NCFs). The non-crimp fabrics (NCFs) are manufactured by depositing fibre tow onto a bed before binding the tow with either stitching or adhesive. This means that instead of being e.g. woven, the fibre tow is held in sheet form to avoid any crimping of the fibres. NCFs have generally better mechanical characteristics than their crimped/woven counterparts. The layered fabric is cut to the desired shape, formed and impregnated via e.g. a resin transfer moulding (RTM) or “wet pressing” operation as known in the art.

One drawback of FRP materials is their cost. Of the two phases in a composite material, the majority of the cost of the material usually lies in the reinforcement/fibre phase. Carbon fibre is a common reinforcement material in high performance engineering applications. A problem with carbon is that it is expensive to process into the required fibre form. Carbon fibres are created from a precursor material which needs to be fiberized and carbonised in a highly energy intensive process. Therefore, it is expensive to purchase as a raw material for manufacture of FRP components.

It is therefore desirable to reduce the amount of fibre reinforcement material used in FRP components.

In most cases, FRP components will undergo specific loads depending on their environment. In the case of the preform 10 of FIG. 1, these loads are managed by providing three layers which extend across the entire component.

It will be understood that in some areas, the reinforcement phase is not carrying significant loads, and as such is effectively redundant. Taking the example of the preform 10 of FIG. 1, in a specific load environment a significant proportion of the fibre may be redundant. This is potentially wasteful and increases the cost of the part unnecessarily. It may also make the part heavier than it needs to be (carbon fibres have a much higher density than the polymer matrix, thereby adding parasitic weight).

### SUMMARY OF THE INVENTION

The present invention aims to obviate or at least mitigate the above described problem and/or to provide improvements generally.

According to the invention there is provided a method and a preform as defined in any of the accompanying claims.

In an embodiment of the present invention there is provided a method of manufacturing a preform comprising the steps of:
forming a reinforcement fabric by:
   depositing a first fibre layer;
   depositing a second fibre layer, wherein the second layer extends partially over the area defined by the first layer, and;
   cutting a plurality of preforms from the reinforcement fabric after the step of forming the reinforcement fabric.

To reduce the amount of reinforcement material used in FRP components, the fibre material thus is positioned only in the areas in which it is required by the load environment and duty cycle of the component. In other words the ply book within the preform is formed to be “load orientated”.

The invention can therefore provide a load-orientated ply-book as a continuous NCF reinforcement fibre from which preforms can be cut.

This is an alternative concept to using either an automated tape layup (ATP) process or an automated fibre placement (AFP) process. In both cases, fibre tow forming layers are directly deposited to form the preform. A problem with this approach is that both ATP and AFP involve significant capital cost to implement. They also introduce a time-consuming step in the production of the preform.

By directly depositing the plies in the required pattern/form before they are cut into preforms, there is no need to implement ATP or AFP. Therefore, the present invention provides the advantages of the load-orientated ply book without the need for expensive and time consuming ATP and AFP manufacturing steps.

In an embodiment of the invention the second fibre layer extends only partially to the outer edges of the first fibre layer. Preferably, the first fibre layer has a perimeter which is defined by the combined outer edges of the first fibre layer, and the second fibre layer extends to a fraction of the perimeter, the fraction between smaller than the complete perimeter of the first fibre layer.

The fraction may comprise 0.2, 0.4, 0.6, 0.8, 0.1-0.4, 0.2-0.9, 0.3-0.8, 0.4-0.7, 0.5-0.9, 0.6-0.95, 0.7-0.9 and/or a combinations of any of the aforesaid values and/or ranges.

Preferably the method comprises the step of depositing a further fibre layer, wherein the further layer extends partially over the area defined by the first layer. The further layer may extend partially over the area defined by the second layer. The further layer may extend over a part of the area defined by the first layer, which area is not covered by the second layer.

Preferably the method comprises the step of connecting the layers to one another, for example by adhering and/or stitching the layers together.

Preferably the second and/or further layer is arranged in relation to a load path of a part which is manufactured from the preform.

In another embodiment, at least one additional layer is deposited in relation to any of the first, second or further layers.

Preferably, a layer comprises unidirectional fiber tows extending in one direction. In a further embodiment, the layers are arranged in relation to one another so that the direction of the tows in the first and second layer differs.

Preferably the second layer is deposited in at least one elongate strip, and in which the fibres of the second layer are aligned with the strip. In other words, the fibres are oriented along the long axis of the strip.

Preferably the method comprises the steps of:
providing a non-crimp fabric manufacturing machine;
forming the reinforcement fabric on the non-crimp fabric manufacturing machine.

Preferably the reinforcement fabric is formed continuously in a first direction by an NCF machine (the “feed direction”).

The second layer may comprise at least one strip spanning the width of the reinforcement fabric in a second direction angled to the first (i.e. angled in relation to the feed direction). A further layer may comprise at least one strip extending in the first direction or at a different angle in relation to the first direction (i.e. in the feed direction or angled thereto and the strip may be crossing the strips of the second layer). The angles between the first layer and any second and further layer or further layers may range from 0 to +/−90 degrees in relation to the first layer, including any angles from +/−20 to +/−80 degrees, +/−30 to +/−60 degrees, and in particular angles of +/−30 degrees, +/−45 degrees and +/−60 degrees.

Preferably the plurality of preforms each comprise part of the first and second layers.

According to the invention there is provided a preform obtained by the method any of the preceding claims.

### DETAILED DESCRIPTION

Embodiments of the invention will now be illustrated by way of example only and with reference to the accompanying drawings in which:

FIG. 1 is an exploded perspective diagrammatic view of a preform of the prior art;

FIG. 2 is a perspective diagrammatic view of a preform according to the invention;

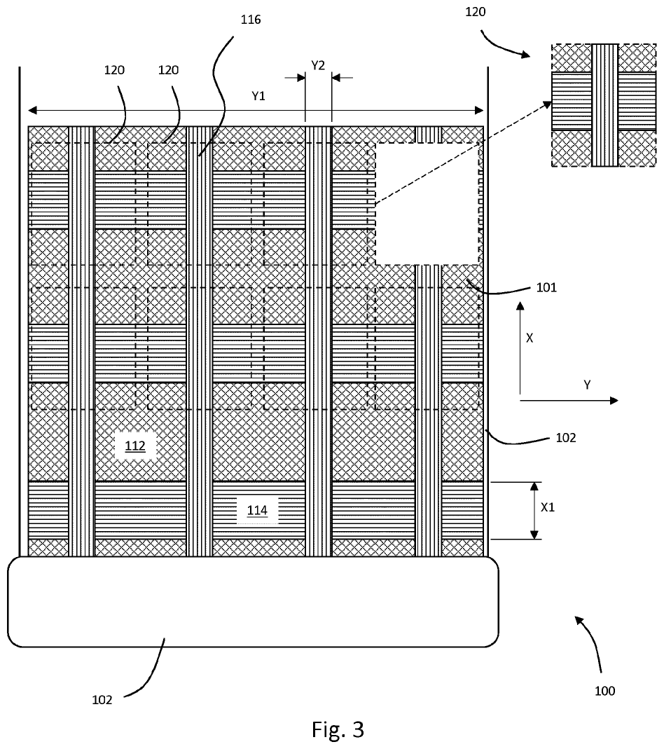

FIG. 3 is a plan diagrammatic view of an apparatus carrying out a method in accordance with the present invention; and;

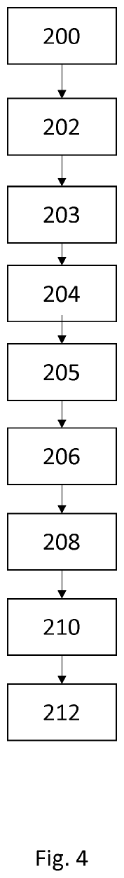

FIG. 4 is a flow diagram of the method of FIG. 3.

Referring to FIG. 2, a preform 120 with a load orientated ply book is shown. The first layer 112 is identical to the first layer 12 of FIG. 1, but the second and third layers 114, 116 have been provided to only partially span the preform 120. The second and third layers 114, 116 only cover part of the area defined by the first layer 12. Therefore the 0 degree and 90 degree fibres are provided only in the areas in which they are required. Clearly, such a part will be less expensive and lighter than the part formed from the preform 10 as shown in FIG. 1.

Referring to FIG. 3 a manufacturing cell 100 comprises an NCF machine 102 having a bed 104. The cell is configured to manufacture the preforms 120. The NCF machine 102 is configured to deposit carbon fibre tow to produce a continuous length of load-orientated non-crimp fabric in a direction X. The machine 102 is configured to produce the first layer 112 of ±45 degree non-crimp fabric 101 having a continuous width Y1. The machine is further configured to generate the second layer 114 of 90 degree fabric. Instead of the second layer covering the entire surface of the first layer, it is deposited in a plurality of strips of width X1, spaced apart in the direction X. The machine is further configured to generate the further layer 116 of 0 degree fabric. The further layer runs in the X direction, but is deposited in a plurality of spaced apart strips of width Y1 in the Y direction.

This arrangement provides a pre-defined load orientated ply book. As shown at the top of FIG. 3 in dashed lines, individual preforms 120 can be cut from the fabric. The preforms 120 are shown spaced-apart for clarity, but it will be understood that in practice they will be adjacent. It will be noted that the preforms 120 do not require the use of ATP or AFP to deposit the second or third layers 114, 116.

Referring to FIG. 4, the sequence of manufacture is shown in more detail.

At step 200, the first layer 112 is deposited in a continuous length by the NCF machine 102. At step 202, the second layer 114 is deposited so as to cover a part of the first layer 112, in this embodiment in strips in the Y direction, spaced apart in the X direction. The fibres of the second layer 114 are oriented in the direction of the strips (i.e. in the Y direction, or at 90 degrees to the X axis). At step 203, the further layer 116 is deposited onto the first and second layers 112, 114. In this embodiment the further layer is strips in the X direction, spaced apart in the Y direction. The fibres of the further layer 116 are oriented in the direction of the strips (i.e. in the Z direction, or at 0 degrees). At step 204, the fibres of the various layers 112,114 116 are stitched together.

At step 206, once the layers have been deposited and connected to one another to form the load orientated fabric 101, preforms 120 are cut.

The preforms 120 are shaped at step 208 (for example by lay up in a mould), impregnated at step 210 and cured at step 212 to form parts having load orientated ply books.

Variations fall within the scope of the present invention.

Although the plies are stitched in the above embodiment, they may be attached by other means such as an adhesive. A thermoplastic polymer binder may be used, which may be provided in e.g. powder form and applied between layers.

Multiple fibre plies may be provided including a first ply, a second ply and multiple further plies. The important step is that the plies are deposited in a load-orientated manner before the preforms are cut from the fabric.

The fibre orientation in each ply may be selected based on the required application. It is not essential for the fibre direction to be parallel to each “strip” forming the ply.

Although depositing plies in strips at 0 and 90 degrees is well suited to most existing NCF machines, this is not essential. The strips may be provided at varying angles ranging from 0 to 90 degrees, preferably from 10 to 80 degrees and more preferably from 30 to 60 degrees including 45 degrees as measured as the smallest angle between the direction of the fibre tows of the first layer in relation to the other layers. In a preferred embodiment, the direction of the tows in at least two layers is symmetrical but at opposing angles in relation to the direction of the fibre tows of a first layer (for example +1-45 degrees, +1-60 degrees).

The present application is not limited to the use of carbon fibres, and may be implemented with other fibre tows including glass fibre, basalt, polyamide based fibres, polyolefin based fibres and aramid fibres.

The invention can be used with any kind of NCF configuration (BiAx, TriAx, QuadAx, in 0°, 90°, +45°, −45° direction and any other fiber direction (everything) in between).

1. A method of manufacturing a preform comprising the steps of:
conjoining a plurality of layers of fiber layers, wherein the lowermost of said fiber layers is a first layer;
wherein the layer of said fiber layers immediately above said first layer is a second layer;
and wherein the perimeter of said second layer is smaller than the perimeter of said first layer, whereby said second layer fits within the perimeter of the first layer.

2. The method according to claim 1, further comprising the step of depositing a further fibre layer on top of said second layer, said further layer comprising a fourth layer, wherein said fourth layer extends partially over the area defined by the first layer.

3. The method according to claim 2, in which said third layer extends partially over the area defined by the second layer.

4. The method according to claim 3, in which said third layer extends over a part of the area defined by the first layer, which area is not covered by the second layer.

5. The method according to claim 4, wherein at least one additional layer is deposited in relation to any of the first, second or third layers.

6. (canceled)

7. The method according to claim 5, further comprising the step of connecting the layers to one another.

8. (canceled)

9. The method according to claim 7, comprising the step of stitching the layers together.

10. (canceled)

11. The method according to claim 9, wherein at least one fiber layer comprises unidirectional fiber tows extending in one direction.

12. (canceled)

13. (canceled)

14. (canceled)

15. (canceled)

16. (canceled)

17. (canceled)

18. (canceled)

19. The method according to claim 9 wherein the ratio between the perimeter of the second layer and the perimeter of the first layer is between 0.1-0.4, and 0.2-0.9.

20. A reinforcement fabric comprising a first layer and a second layer, each layer comprising unidirectional fibre tows arranged parallel to one another, the direction of the tows of each layer differing from the direction of the tows of the other layer, wherein the tows of the second layer extend partially over the first layer.

21. The reinforcement fabric according to claim 20, comprising a further layer comprising unidirectional fibre tows arranged parallel to one another, wherein the further layer extends partially over the area defined by the first layer.

22. The reinforcement fabric according to claim 21, in which the further layer extends partially over the area defined by the second layer.

23. The reinforcement fabric according to claim 22, in which the further layer extends over a part of the area defined by the first layer, which area is not covered by the second layer.

24. The reinforcement fabric according to claim 23, in which the layers are connected to one another.

25. (canceled)

26. (canceled)

27. (canceled)

28. The reinforcement fabric according to claim 24, in which the layers are constructed from non-crimped fabrics.

29. The reinforcement fabric according to claim 28, in which the first fibre layer has a perimeter which is defined by the combined outer edges of the first fibre layer, and the second fibre layer is deposited to extend to a fraction of the perimeter of the first fibre layer, the fraction between smaller than the complete perimeter of the first fibre layer.

30. The reinforcement fabric according to claim 29, wherein the fraction comprises between 0.1-0.4, and 0.2-0.9.

31. (canceled)

32. (canceled)

33. (canceled)
